(19) United States
(12) Patent Application Publication
(10) Pub. No.: US 2011/0111187 A1
(43) Pub. Date: May 12, 2011

(54) PRINTED MATERIAL AND WATER-BASED COATING AGENT

(75) Inventors: Seiichi SOUMA, Tomi-city (JP); Akira MINEMURA, Tomi-city (JP); Isao TABAYASHI, Tomi-city (JP)

(73) Assignee: MIMAKI ENGINEERING Co., Ltd., Tomi-city (JP)

(21) Appl. No.: 12/948,668

(22) Filed: Nov. 17, 2010

Related U.S. Application Data
(63) Continuation of application No. PCT/JP2008/073294, filed on Dec. 22, 2008.

(51) Int. Cl. B32B 5/24; B32B 3/10; C09D 175/04

(52) U.S. Cl. 428/196; 524/591

(57) ABSTRACT

A printed material includes a cloth medium, a printed layer, and a coating layer. The cloth medium is washable. The printed layer is printed on the cloth medium with a water-based pigment ink including an anionic resin by using an inkjet printing method. The coating layer is provided on at least one of an upper side and a lower side of the printed layer by applying a water-based coating agent including anionic water-based resin particles.

### CROSS-REFERENCE TO RELATED APPLICATIONS

The present application is a continuation application of International Application No. PCT/JP2008/073294, filed Dec. 22, 2008. The contents of this application are incorporated herein by reference in their entirety.

### BACKGROUND OF THE INVENTION

1. Field of the Invention

The present invention relates to a printed material and a water-based coating agent.

2. Discussion of the Background

Conventionally, screen printing is widely used when performing commercial printing (see, e.g., Japanese Unexamined Patent Application Publication No. 1990-295787). An ink containing a high viscosity binder is generally used in the screen printing. Therefore, it is possible to perform printing having a high color fastness to washing on a medium such as a cloth.

Performing printing with an inkjet printing method on a medium such as a cloth is being studied. An ink used in the inkjet printing method, however, must have a low viscosity. A low-viscosity ink has, however, a low color fastness to washing.

An ink is discharged from minute holes in the inkjet printing method. Therefore, with an amount of ink-discharge sustainable for practical use, an amount of binder contained in the ink deposited on the surface of the medium such as the cloth etc. is less. Consequently, during actual use, such as when washing the medium, the ink is physically peeled-off from the surface of the medium, i.e., sufficient color fastness to washing and friction durability may not be secured.

Thus, generally there is a tradeoff between an increase in the durability due to an increase in the viscosity of the ink used in the inkjet printing method and an operating reliability. Therefore, it is technically difficult to obtain a printed material that can present a required commercial quality by modifying only the ink.

Moreover, a coating agent of macromolecular system is easily eluted in an acidic environment when a terminal group is anionic. Thus, there is a need for a coating agent that is resistant to acids.

### SUMMARY OF THE INVENTION

According to one aspect of the present invention, a printed material includes a cloth medium, a printed layer, and a coating layer. The cloth medium is washable. The printed layer is printed on the cloth medium with a water-based pigment ink including an anionic resin by using an inkjet printing method. The coating layer is provided on at least one of an upper side and a lower side of the printed layer by applying a water-based coating agent including anionic water-based resin particles.

A water-based coating agent constitutes the coating layer in the above-described printed material. The water-based coating agent contains at least a polyurethane resin dispersion, an anti-drying agent, and water.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram of a configuration of a printed material according to an embodiment of the present invention; and

FIG. 2 is a flowchart showing an example of a printing method by which the printed material is obtained.

### DESCRIPTION OF THE EMBODIMENTS

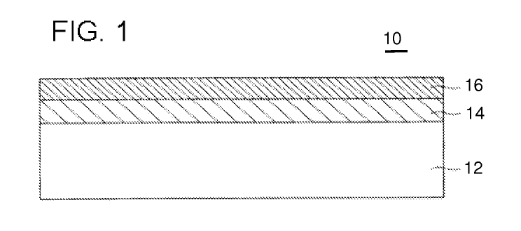

Exemplary embodiments according to the present invention are explained below while referring to the accompanying drawings, wherein like reference numerals designate corresponding or identical elements throughout the various drawings. FIG. 1 is a schematic diagram of a configuration of a printed material 10 according to an embodiment of the present invention. The printed material 10 is a printed material (character printed material) printed by using an inkjet printing method and it includes a medium 12, a printed layer 14, and a coating layer 16.

The medium 12 is a washable cloth medium. The cloth can be a woven cloth, a knit (knit cloth), a lace, a felt, or a nonwoven cloth. Fibers that constitute the cloth can be cotton fibers or synthetic fibers.

The printed layer 14 is a layer of ink formed when printing is performed on the medium 12 by using the inkjet printing method. In the present embodiment, the printed layer 14 is formed with a water-based pigment ink including an anionic resin. The coating layer 16 is a layer obtained by coating a water-based coating agent including anionic water-based resin particles. In the present embodiment, the coating layer 16 is formed on the printed layer 14. When such a configuration is employed, because the surface of the printed layer 14 is covered, a color fastness to washing and a friction durability of the printed material 10 can be appropriately enhanced.

Meanwhile, the coating layer 16 can be formed below the printed layer 14. When the coating layer 16 is formed below the printed layer 14, for example, because an adhesion between the printed layer 14 and the medium 12 becomes stronger, the color fastness to washing and the friction durability of the printed material 10 can be appropriately enhanced. Meanwhile, the coating layer 16 can be formed on both the sides, above and below, of the printed layer 14.

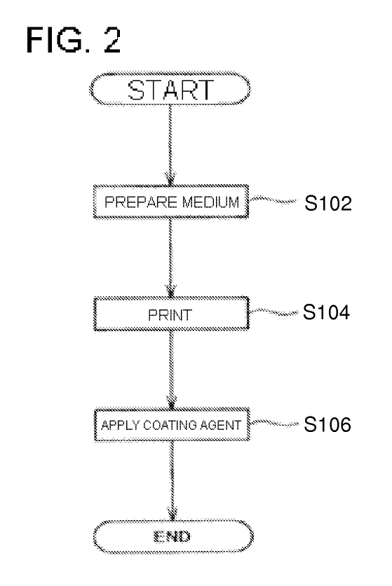

FIG. 2 is a flowchart showing an example of a printing method by which the printed material 10 is obtained. This printing method involves performing printing on the medium 12, which is a washable cloth, by using the inkjet printing method. More specifically, first, the medium 12 is prepared (preparation step S102) by performing an operation of setting the medium 12 on, for example, a printing apparatus.

Subsequently, printing is performed on the medium 12 with the water-based pigment ink including the anionic resin by using the inkjet printing method (printing step S104), thereafter, the water-based coating agent including the anionic water-based resin particles is applied to the medium (coating agent applying step S106).

By employing this method, appropriate printing can be performed on the medium 12, which is a cloth, by using the inkjet printing method, while, for example, enhancing the color fastness to washing and the friction durability. In addition, the color fastness to washing and the friction durability can be enhanced without defiling the external appearance. Thus, according to the embodiment, an inkjet textile printed material that is superior in the color fastness to washing and the friction durability can be obtained. Meanwhile, when the coating layer 16 is formed below the printed layer 14, the water-based coating agent is applied to the medium 12 before performing the printing step 104.

A method for applying the coating agent at the coating agent applying step S106 can be selected from among the inkjet printing method, a spray application method, and a screen application method. At the coating agent applying step S106, it is preferable to perform thermal compression after the water-based coating agent is applied, for example, by using the spray application method. It is possible to appropriately improve a fixability of the water-based coating agent with respect to the water-based pigment ink by adopting such a configuration.

A pH of the water-based coating agent applied at the coating agent applying step S106 can be, for example, from 7 to 10. A viscosity of the water-based coating agent can be, for example, from 1 mPa·s to 2000 mPa·s (25 degree centigrade). An amount of a solid resin component in the water-based coating agent after coating, for example, at least in a printed area of the medium, is from 0.5 milligram per square centimeter to 10 milligrams per square centimeter.

The water-based coating agent includes anionic polyurethane resin particles as the anionic water-based resin particles. By employing this configuration, the color fastness to washing and the friction durability can be appropriately enhanced while securing a flexibility.

It is preferable that a tensile strength of a film material of the anionic polyurethane resin is from 5 mPa to 70 mPa.

Meanwhile, in terms of a solid content, it is preferable that the anionic polyurethane resin particles in the water-based coating agent be from 5 mass % to 50 mass %, and be more preferably from 2 mass % to 25 mass %. Moreover, a tensile strength of a film of the water-based coating agent be preferably from 5 MPa to 50 MPa, and be more preferably from 30 MPa to 50 MPa.

Moreover, a resin structure of the anionic polyurethane resin particles can be selected from among, for example, a polyester, a polyether, and a polycarbonate. It is particularly preferable that the water-based coating agent contains particles of a polyether-type anionic polyurethane resin having a resin structure of the polyether as the anionic water-based polyurethane resin.

Meanwhile, the water-based coating agent contains, in terms of a solid content, the anionic polyurethane resin particles from 5 mass % to 50 mass %, and contains an anti-drying agent from 5 mass % to 50 mass %. It is possible to appropriately prevent clogging of nozzles of an inkjet head by adopting such a configuration. This enables printing to be performed more appropriately by using the inkjet printing method.

### CONCRETE EXAMPLES

The embodiments of the present invention are explained below in more detail by way of concrete examples and comparative examples. Meanwhile, the various conditions explained below are just examples and they should not be taken as limiting the present invention. For example, an amount of and an applying amount of the anionic water-based resin particles (anionic polyurethane resin particles) in the water-based coating agent can be appropriately changed depending on a surface roughness, a thickness, and an intended texture of the printed material.

### First Concrete Example

A composition (composition example A) containing 50% HYDRAN WLS-202 made by DIC corporation and 50% water was used as an over-coating agent in a first concrete example. HYDRAN WLS-202 contains polyether-type resin component as the anionic water based resin particles. Moreover, in the first concrete example, the composition example A as the water-based coating agent was applied after performing printing by using a colored ink.

### Second Concrete Example

A composition (composition example B) containing 50% HYDRAN WLS-213 made by DIC corporation and 50% water was used as the over-coating agent in the first concrete example. HYDRAN WLS-213 contains a polycarbonate-type resin component as the anionic polyurethane resin particles. Moreover, in the second concrete example, the composition example B as the water-based coating agent was applied after performing printing by using the colored ink.

### First Comparative Example

A composition (composition example C) containing 50% HYDRAN CP-7030 made by DIC corporation and 50% water was used as the over-coating agent in a first comparative example. HYDRAN HYDRAN CP-7030 contains a polyester-type resin component as cationic water-based resin particles. Moreover, in the second comparative example, the composition example C as the water-based coating agent was applied after performing printing by using the colored ink.

### Evaluation

Evaluation of an Enhancement of the Color Fastness to Washing and the Friction Durability

Whether there is an enhancement of the color fastness to washing and the friction durability was examined by performing the following steps:

(1) In the printing step, an A4-size pattern (624 square centimeters) was printed on a T-shirt, which is a cloth, by using an inkjet textile printing pigment that is the water-based pigment ink containing the anionic resin.

(2) Baking was performed at 160 degree centigrade for 60 seconds.

(3) In the coating agent applying step, a 20-gram over-coating agent was applied by hand spraying on the A4-size printed area. After applying the over-coating agent, heat-curing was performed by using a hot press.

(4) Tests for checking the color fastness to washing and the friction durability were conducted as per a JIS dyeing inspection.

Evaluation of an Enhancement of a Resistance to Chemicals

Furthermore, whether there is an enhancement of the resistance to chemicals was examined by performing the following steps:

(1) In the printing step, an A4-size pattern (624 square centimeters) was printed on a T-shirt, which is a cloth, by using the inkjet textile printing pigment that is the water-based pigment ink containing the anionic resin.

(2) Baking was performed at 160 degree centigrade for 60 seconds.

(3) In the coating agent applying step, a 20-gram over-coating agent was applied by hand spraying on the A4-size printed area. After applying the over-coating agent, heat-curing was performed by using a hot press.

(4) A resistance to chemicals was examined with respect to acidic solutions.

Meanwhile, a textile pigment (cyan color) made by Mimaki Engineering was used as the colored ink for printing. The printing was carried out under the conditions of 720-720 dpi, one direction printing, 2-pass 1-coat, and 100% density.

Moreover, a white T-shirt made by Printstar was used. The over-coating agent was heat-hardened at 160 degree centigrade for 180 seconds.

The color fastness to washing is the one defined by JIS L 0844 A-2. The friction durability is the one defined by JIS L 0849II-type.

Tests for the color fastness to washing and the friction durability were performed at Japan Dyers' Inspection Institute Foundation, Tokyo Office, as an inspecting authority.

In the test for the resistance to chemicals, the printed material (T-shirt) was dipped in each of water, acetic acid as an acidic solution for three days, and changes in an external appearance of the printed area were visually observed and evaluated.

The results of the tests for the color fastness to washing and the friction durability are shown in Table 1. The results of the tests for the resistance to chemicals are shown in Table 2.

TABLE 1

| | Color fastness | Friction | Friction |
|---|---|---|---|
| | to washing | durability | durability |
| | (discoloration) | (dry) | (wet) |
| First | 4 to 5 | 5 | 4 to 5 |
| concrete | | | |
| example | | | |
| Second | 4 to 5 | 5 | 3 to 4 |
| concrete | | | |
| example | | | |
| First | 4 | 2 | 2 |
| comparative | | | |
| example | | | |

TABLE 2

| | | Acetic acid |
|---|---|---|
| | Water | 100% |
| First | elution not | elution not |
| concrete | seen | seen |
| example | | |
| (anionic) | | |
| Second | elution not | elution not |
| concrete | seen | seen |
| example | | |
| (anionic) | | |
| First | elution not | elution seen |
| comparative | seen | |
| example | | |
| (cationic) | | |

As shown in Table 1, it was confirmed that the color fastness to washing is better in the first concrete example and the second concrete example in comparison to the first comparative example. Moreover, it was confirmed that the friction durability is better in the first concrete example and the second concrete example in comparison to the first comparative example in both dry and wet conditions.

Furthermore, as shown in Table 2, it was confirmed that the resistance to chemicals is better in the first concrete example and the second concrete example in comparison to the first comparative example.

Exemplary embodiments according to the present invention are explained above; however, the technical scope of the present invention is not limited to what has been disclosed in the above embodiments. It is clear that a person skilled in the art can make various changes or modifications to the above embodiments. It is clear from the scope of the claims that the product obtained by making such changes or modifications also falls within the technical scope of the present invention.

The present invention can be widely applied to a printed material printed by using, for example, an inkjet printing method, and to a water-based coating agent used for the printed material.

According to the embodiment of the present invention, a printed material includes a coating layer provided on at least one of an upper side and a lower side of the printed layer by applying a water-based coating agent including anionic water-based resin particles. Therefore, a color fastness to washing and a friction durability can be enhanced without defiling the external appearance. An elution of the coating agent by acidic solutions is decreased, and a resistance to chemicals can be enhanced.

Moreover, because the water-based coating agent according to the embodiment of the present invention includes the anionic water-based resin particles, when such a water-based coating agent is used, a printed material can be obtained whose color fastness to washing and friction durability can be enhanced without defiling the external appearance. In addition, an elution of the coating agent by acidic solutions is decreased, and a printed material that is excellent in the resistance to chemicals can be obtained.

Obviously, numerous modifications and variations of the present invention are possible in light of the above teachings. It is therefore to be understood that within the scope of the appended claims, the invention may be practiced otherwise than as specifically described herein.

1. A printed material comprising:
a cloth medium that is washable;
a printed layer that is printed on the cloth medium with a water-based pigment ink including an anionic resin by using an inkjet printing method; and
a coating layer provided on at least one of an upper side and a lower side of the printed layer by applying a water-based coating agent including anionic water-based resin particles.

2. The printed material according to claim 1, wherein the coating layer is formed by using a coating method selected from among the inkjet printing method, a spray application method, and a screen application method.

3. The printed material according to claim 1, wherein the coating agent includes the anionic water-based resin that includes anionic resin particles that are anionic polyurethane resin particles.

4. The printed material according to claim 3, wherein a resin structure of the anionic polyurethane resin is that of a polyether or a polycarbonate.

5. The printed material according to claim 3, wherein a tensile strength of a film material of the anionic polyurethane resin is from 5 mPa to 70 mPa.

6. The printed material according to claim 1, wherein the medium comprises a textile.

7. The printed material according to claim 1, wherein the medium is made from cotton or synthetic resin.

8. A water-based coating agent constituting the coating layer in the printed material according to claim 1, wherein the water-based coating agent contains at least a polyurethane resin dispersion, an anti-drying agent, and water.

9. The water-based coating agent according to claim 8, wherein a tensile strength of a film of the water-based coating agent is from 5 MPa to 50 MPa.

10. The water-based coating agent according to claim 8, wherein a pH of the water-based coating agent is from 7 to 10.

11. The water-based coating agent according to claim 8, wherein a viscosity of the water-based coating agent at 25 degree centigrade is from 1 MPa·s to 2000 MPa·s.

12. The printed material according to claim 2, wherein the coating agent includes the anionic water-based resin that includes anionic resin particles that are anionic polyurethane resin particles.

13. The printed material according to claim 3, wherein a resin structure of the anionic polyurethane resin is a resin structure of a polyether or a polycarbonate.

14. The printed material according to claim 4, wherein a tensile strength of a film material of the anionic polyurethane resin is from 5 mPa to 70 mPa.

15. The printed material according to claim 12, wherein a tensile strength of a film material of the anionic polyurethane resin is from 5 mPa to 70 mPa.

16. The printed material according to claim 13, wherein a tensile strength of a film material of the anionic polyurethane resin is from 5 mPa to 70 mPa.

17. The water-based coating agent according to claim 9, wherein a pH of the water-based coating agent is from 7 to 10.

18. The water-based coating agent according to claim 9, wherein a viscosity of the water-based coating agent at 25 degree centigrade is from 1 MPa·s to 2000 MPa·s.

19. The water-based coating agent according to claim 10, wherein a viscosity of the water-based coating agent at 25 degree centigrade is from 1 MPa·s to 2000 MPa·s.

20. The water-based coating agent according to claim 17, wherein a viscosity of the water-based coating agent at 25 degree centigrade is from 1 MPa·s to 2000 MPa·s.
